(19) United States
(12) Patent Application Publication
(10) Pub. No.: US 2010/0107124 A1
(43) Pub. Date: Apr. 29, 2010

(54) SYSTEM AND METHODS FOR ESTABLISHING A COMMUNICATION LINK BETWEEN NETWORK END USERS

(75) Inventor: Jonathan D. HERBRUCK, Chardon, OH (US)

Correspondence Address: HAHN LOESER & PARKS, LLP, One GOJO Plaza, Suite 300, AKRON, OH, 44311-1076, US

(73) Assignee: SP ANNOTATED NETWORK, LTD., Concord, OH (US)

(21) Appl. No.: 12/605,330

(22) Filed: Oct. 24, 2009

Related U.S. Application Data
(60) Provisional application No. 61/108,311, filed on Oct. 24, 2008.

(51) Int. Cl. G06F 15/16; H04L 9/32; G06F 21/00; G06F 3/048; G06F 9/445

(52) U.S. Cl. 715/835; 709/227; 726/28; 717/176

(57) ABSTRACT

A method of customizing information that is displayed on a computer via a communication portal may include providing first and second computer program products executable on a computer. The computer program products prompt an end user to install the first computer program product and to enter user-specific information that is received by the second computer program product. A display portal is opened that displays information responsive to the user specific information entered.

### CROSS-REFERENCE TO RELATED APPLICATIONS

This patent application claims the benefit of U.S. Provisional Patent Application No. 61/108,311, filed Oct. 24, 2008, the disclosure of which is expressly incorporated by reference herein.

### TECHNICAL FIELD

The present invention pertains to methods and systems for grouping web links and categorizing users.

### BACKGROUND OF THE INVENTION

Many people today are well acquainted with the use of computers and software, especially as it pertains to the Internet. In the past, the Internet has been used for relatively simple tasks, like sending e-mails or electronic files. As more content has been made available, it has become a valuable tool for personal as well as professional use. In more recent times, the Internet has become well known for such tasks as advertising, information gathering and tracking, and product sales, just to name a few. In fact, “e-commerce” is commonplace in today's market and is the primary venue for business transactions for many companies.

End users of the Internet are well acquainted with web browsers, which provide a portal for linking two or more computers. A person simply enters an address or address alias for access to content located on another computer. In certain instances, security is incorporated, requiring the user to verify his or her authority for accessing a particular web site or database. To facilitate convenient use of the Internet, some web browsers feature a file folder that stores web addresses, known as “links,” for web sites selected and saved by the end user. When selected, a drop down menu is populated with the list of links. The end user need only click on the link with the mouse pointer to establish the network connection.

Still, the process of operating a computer or opening a web browser is unfamiliar to many in society today. Web addresses tend to be lengthy, with a variety of case sensitive characters, punctuation and other unique requirements. Many times, the actual web site desired is not discernable from the web address alone. Furthermore, web addresses can change as a site's developers and owners add features or refine their site.

What is needed is an easy to use system that establishes a portal for connecting to a group of web links that is managed by a client side administrator. A primary purpose of this invention is to provide such an arrangement with its various attendant advantages.

### BRIEF DESCRIPTION OF THE DRAWINGS

FIG. 1 is a flowchart according to the embodiments of the subject invention representing a client system process.

FIG. 2 is a flowchart according to the embodiments of the subject invention representing a server system process.

FIG. 3a is a schematic representation of a communication networking.

FIG. 3b is a flowchart according to the embodiments of the subject invention representing a mobile system process.

FIG. 4 is a schematic representation of a user display screen according to the embodiments of the subject invention.

FIG. 5 is a schematic representation of a user display screen according to the embodiments of the subject invention.

FIG. 6 is a schematic representation of a user display screen according to the embodiments of the subject invention.

FIG. 7 is a schematic representation of a user display screen according to the embodiments of the subject invention.

FIG. 8 is a schematic representation of a user display screen according to the embodiments of the subject invention.

FIG. 9 is a schematic representation of a user display screen according to the embodiments of the subject invention.

FIG. 10a is a schematic representation of a user display screen with an original icon place on a desktop according to the embodiments of the subject invention.

FIG. 10b is a schematic representation of a start menu with an original icon according to the embodiments of the subject invention.

FIG. 10c is a schematic representation of an embodiments of the subject invention running in the background of a host system.

FIG. 11 is a schematic representation of a user display screen according to the embodiments of the subject invention.

FIG. 12 is a schematic representation of a user display screen according to the embodiments of the subject invention.

FIG. 13 is a schematic representation of a user display screen with a user ID according to the embodiments of the subject invention.

FIG. 14 is a schematic representation of a user display screen with a new icon according to the embodiments of the subject invention.

FIG. 15 is a schematic representation of a communication portal according to the embodiments of the subject invention.

FIG. 16 is a schematic representation of a user display screen according to the embodiments of the subject invention.

FIG. 17 is a schematic representation of a user display screen according to the embodiments of the subject invention.

FIG. 18 is a schematic representation of a user display screen according to the embodiments of the subject invention.

FIG. 19 is a schematic representation of a user display screen with drop down menu according to the embodiments of the subject invention.

FIG. 20 is a schematic representation of a user display screen with drop down menu according to the embodiments of the subject invention.

FIG. 21 is a schematic representation of a user display screen with drop down menu according to the embodiments of the subject invention.

FIG. 22 is a schematic representation of a user display screen according to the embodiments of the subject invention.

FIG. 23 is a schematic representation of a user display screen according to the embodiments of the subject invention.

FIG. 24 is a schematic representation of a user display screen according to the embodiments of the subject invention.

FIG. 25 is a schematic representation of a user display screen according to the embodiments of the subject invention.

### DETAILED DESCRIPTION OF THE INVENTION

Referring now to the drawings wherein the showings are for purposes of illustrating embodiments of the invention only and not for purposes of limiting the same, systems and methods of communicating between user entities have been uniquely developed that utilize processor based hardware connected via a network. The processor based hardware, which may incorporate one or more microcomputers, may be connected to a wide area network, such as the Internet, or alternatively to a local area network. The processor based hardware, referred to herein as processor systems, may be programmed with software that establishes a communication link between a system operated by an end user, termed client or client system, and a host, termed server system. The hardware comprising the systems may be similar in construction and/or configuration, or different in any manner that still allows the systems to communicate over a network and to execute software as described herein.

In one particular embodiment of the subject invention, the processor system may be comprised of one or more logic processor-based systems such as personal computers, servers, work stations, as well as portable processor based devices, including but not limited to mobile phones, I-Pods®, and/or PDAs (Personal Digital Assistants). In one embodiment, the processor system may comprise a microcomputer for performing the functions of the processor system. Other embodiments contemplate the use of a mini-computer, mainframe computer or any device suitable for communicating over a network as may be used in accordance with the embodiments of the subject invention. The processor system, which may be a microcomputer, may include one or more microprocessors having support circuitry. For purposes of discussion, support circuitry encompasses electronic memory, such as RAM or ROM, along with other peripheral support circuitry that facilitate operation of a computer. The processor system may also include data storage devices such as hard disk drives, optical storage devices, flash memory, and the like for the storage and retrieval of data or any type information. The processor system may further incorporate or be connected to various output devices such as display screens, monitors and/or printers.

Additionally, the processor system may utilize any of a variety of input devices. Examples may include but are not limited to: keyboards, scanners, microphones and bar code readers. Still, any type of computer related I/O (Input/Output) device that facilitates interaction with the processor system may be chosen with sound engineering judgment. The processor system may further include network cards and/or transceivers for connecting to a network, as indicated above, which may be a WAN (Wide Area Network). The WAN may be connected by hardwire connections or through wireless communication devices. Still, any manner of connecting to a network may be chosen with sound engineering judgment as is appropriate for use with the embodiment of the subject invention. Persons of ordinary skill in the art will realize that established communication protocols, like for TCP/IP, may be used to transmit information to and/or from the processor system. In that the construction of computers and the use of communication protocols are known in the art, no further explanation will be offered at this time.

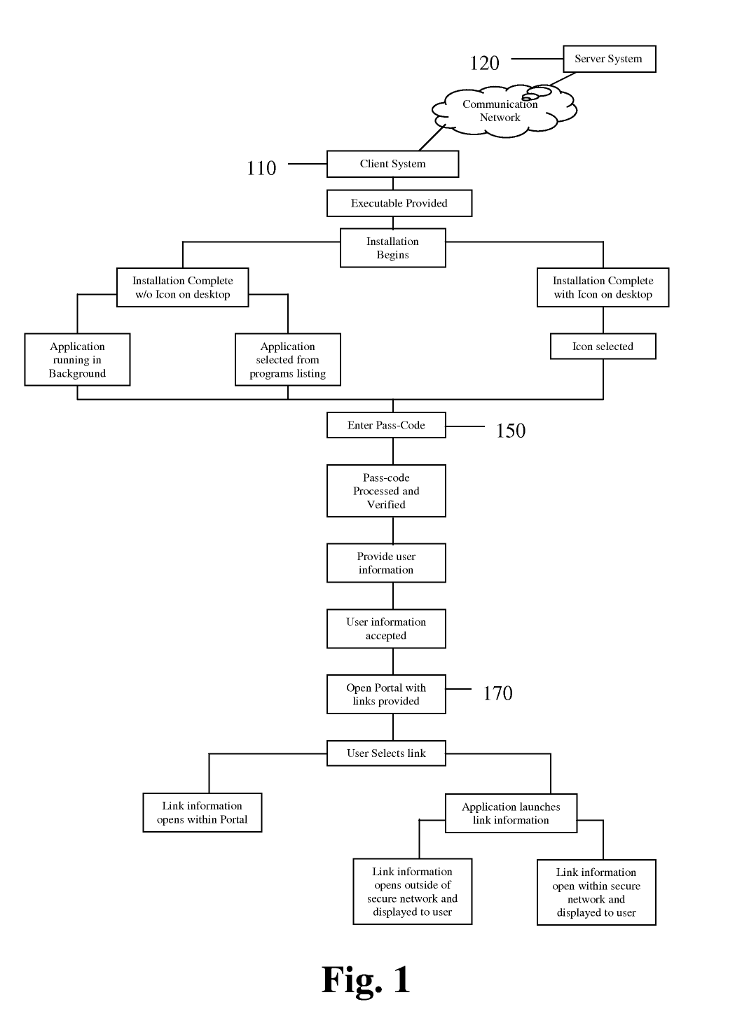

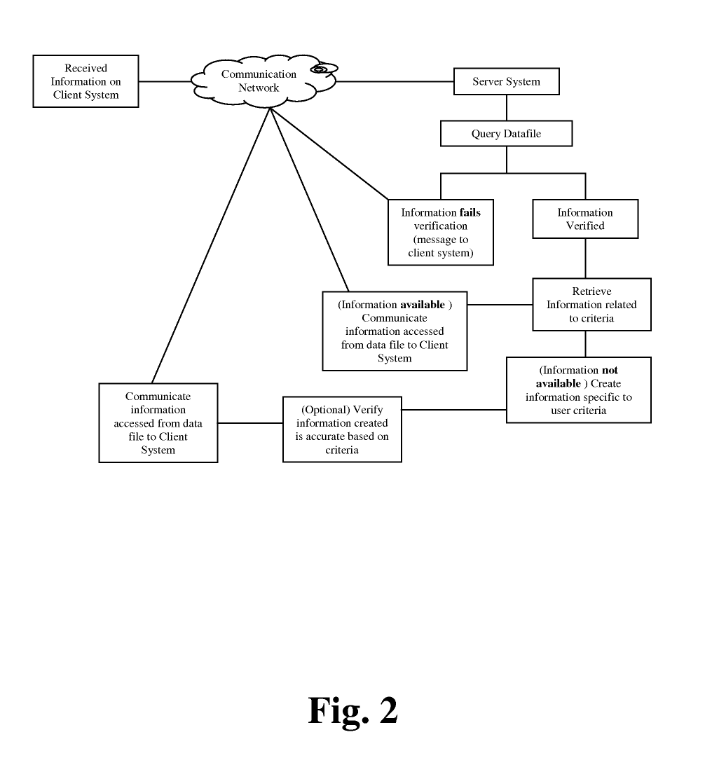

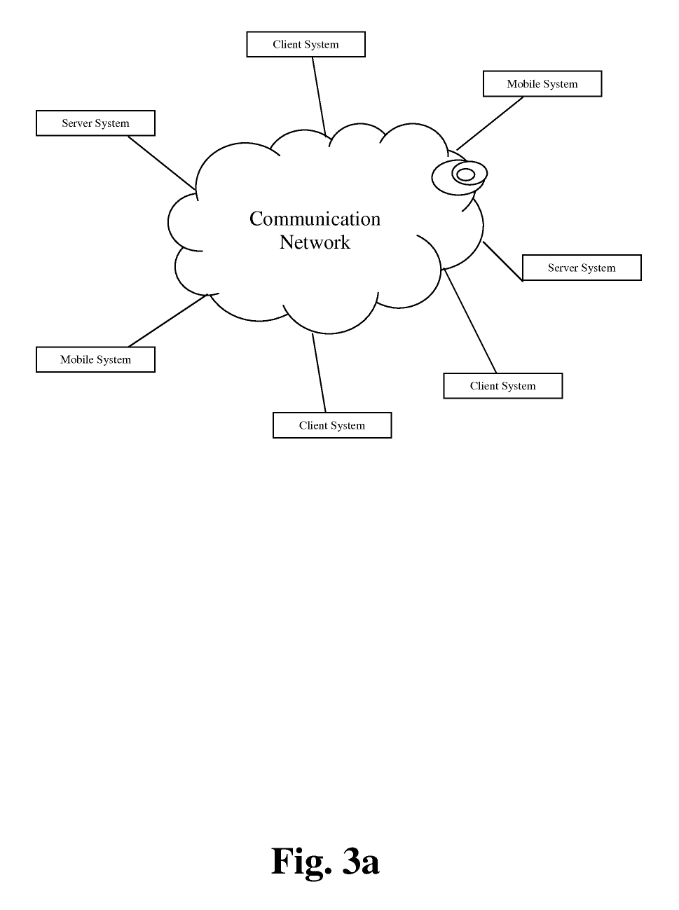

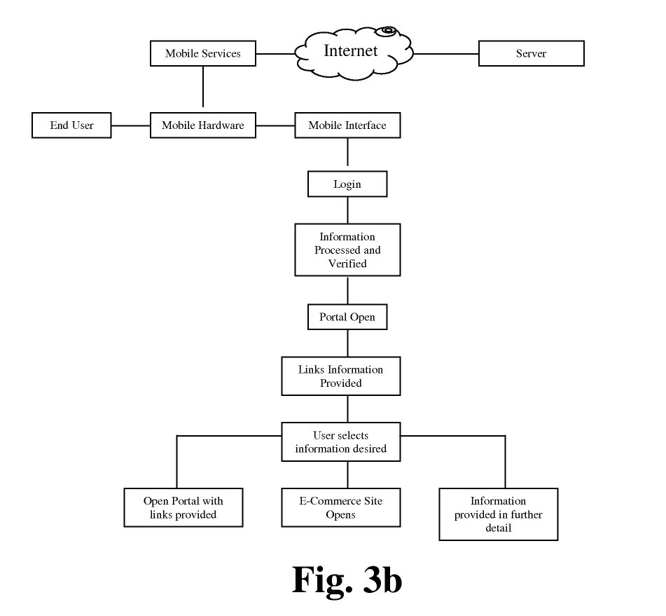

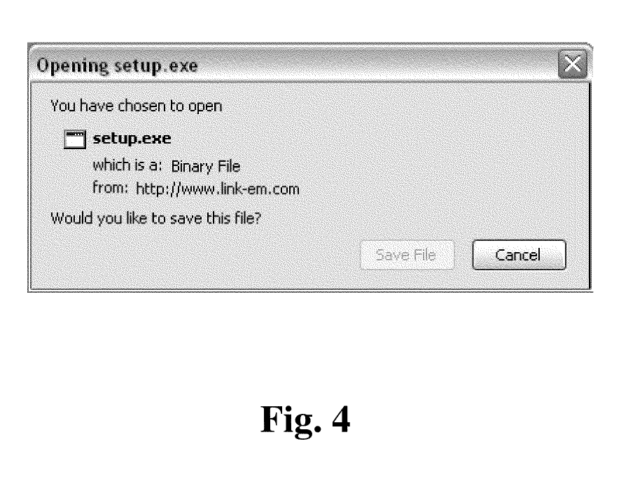

With reference to FIG. 1, the processor system may function to execute software, referred to as linking software, designed to establish a telecommunication link between different systems. In one particular embodiment, the linking software establishes a network connection between a host or server system 120 and a client system 110. Please note, in various embodiments of the present invention, a host system may function as a client system or server system depending on which hardware the server application is installed. It will be appreciated by persons of skill in the art that through the use of network protocols and microprocessor based systems, multiple connections may be established between the server system and a plethora of client systems as shown in FIG. 3a. In this manner, the host system 120 may communicate with a plurality of end users at substantially the same time, as will be discussed further in a subsequent paragraph.

The linking software may comprise two software components: a client installation application and an administrator utility. The first software component, i.e. the client installation application, may function to install application software onto the client system. In one embodiment, the client side application software may identify the type of user registering with the host, to be discussed in detail below. The second software component may reside on the server system and may function to administrate the information presented to the end user via the established network connection.

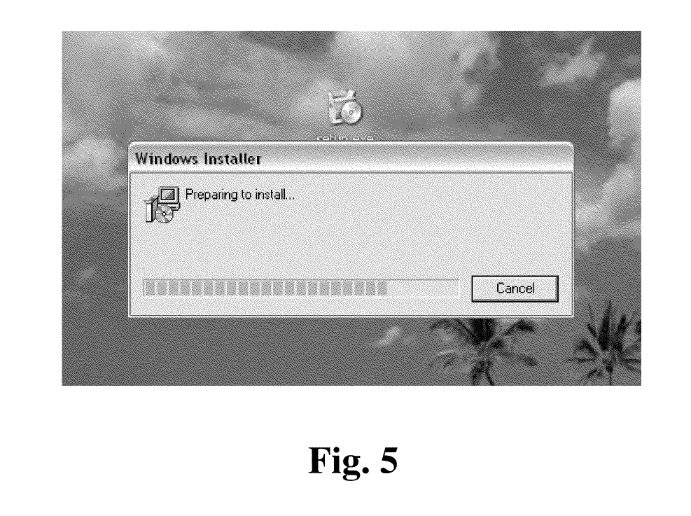

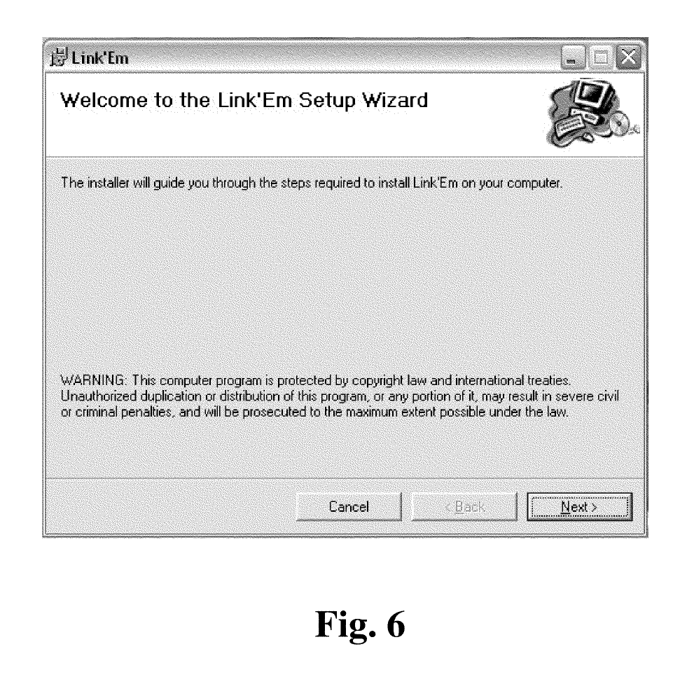

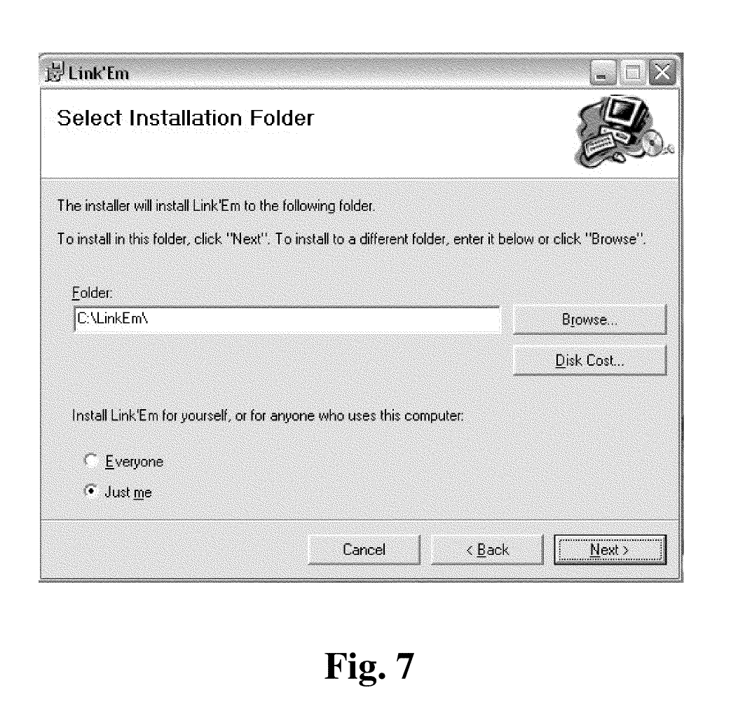

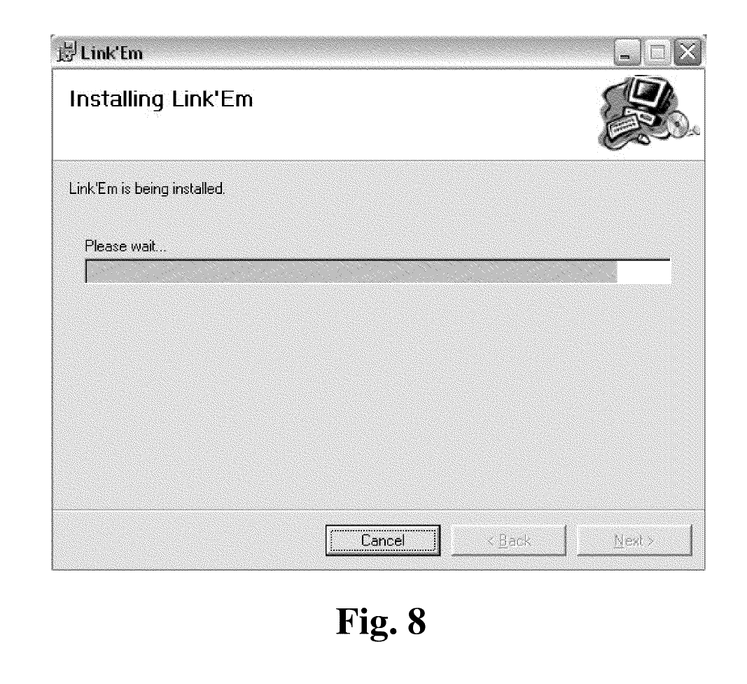

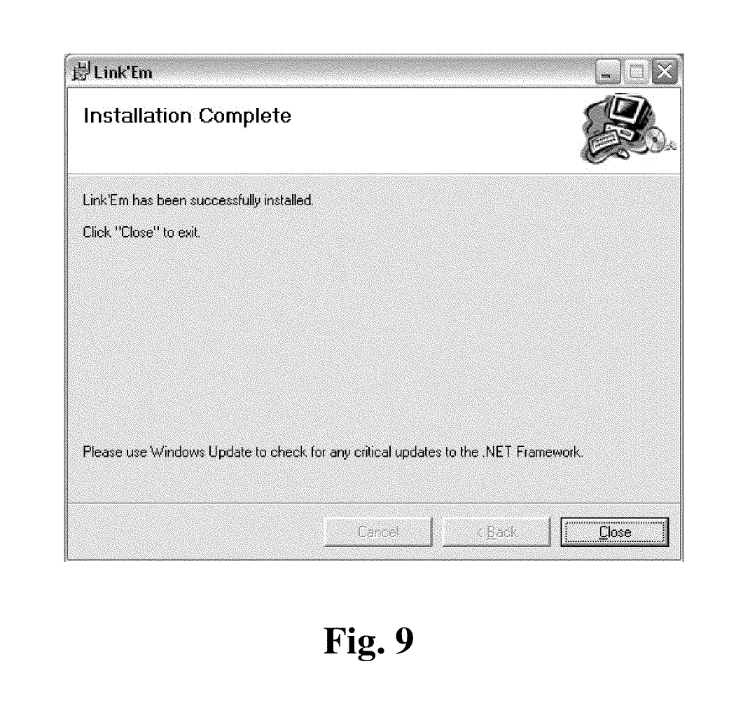

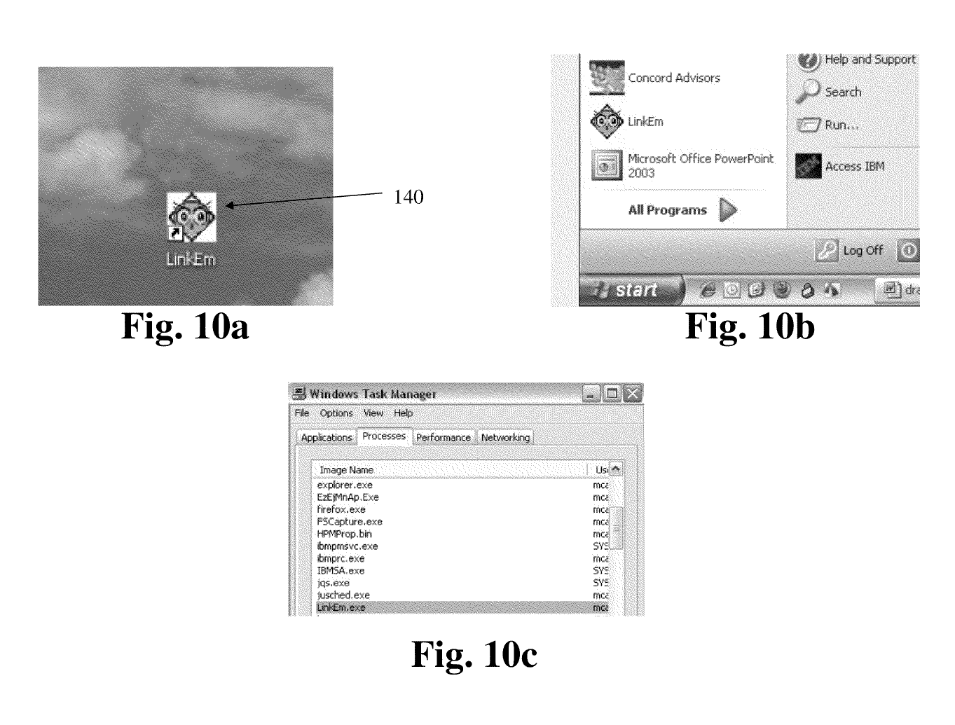

With continued reference to FIG. 1 and the linking software source code incorporated herein by reference, the client installation application may comprise a file having executable code, which may be delivered to the client system 110 by directly connecting with the host 120 via a WAN, e.g. the Internet, e-mail, static memory storage devices such as CD-ROMS or flash devices, any other means chosen with sound judgment. The end user may then download or install the file onto the client system 110 using a software proprietary application installer, or an installer application local to the operating system, i.e. Windows® Installer or MSI (Microsoft® installer) as shown in FIG. 5, or by any other means chosen with sound engineering judgment For illustrative purposes only, the embodiments of the subject invention will be described in the context of a microcomputer executing a Windows® based operating system. However, persons of ordinary skill in the art will understand the application to any processor based system and any corresponding operating system. With further reference to FIG. 10, according to one particular embodiment, the installed client application initially places an icon 140 directly onto the display screen “desktop” of the client's computer. In an alternate embodiment, the end user may elect not to have the icon appear on the desktop. In this instance, the user may elect to have the program appear in the start up application folder as shown in FIG. 10b, in their programs or application folder only (not shown), a system command (not shown), or placed in any system menu of their choice (not shown). As shown in FIG. 10c, the user may alternatively elect to run the application at start up or upon initial execution in the background of their system. When executed by the end user, the icon 140 will facilitate the operation of the client side application setting up the client system for connection with the host 120, i.e. server system, which in the current embodiment is also a computer, or computer server. The protocol, i.e. IP address, web address, user information or the like, to connect with the host 120 may be embedded in the source code, downloaded during the installation (prior to being fully connected with the host), or inputted by the end user. In one particular embodiment the protocol is embedded in the source code itself. In an alternate embodiment, the server application may run on the client system 110, depending on the needs of the client In this embodiment the server system 120 and the client system 110 share the same hardware. If the server application is installed on the client system 110, a direct link may be established using drive or program mapping to connect the applications. However, it is noted that in various embodiments, the connection is made through a network allowing the client system 110 access to the server system 120, which in various embodiments may be a server system web page interface.

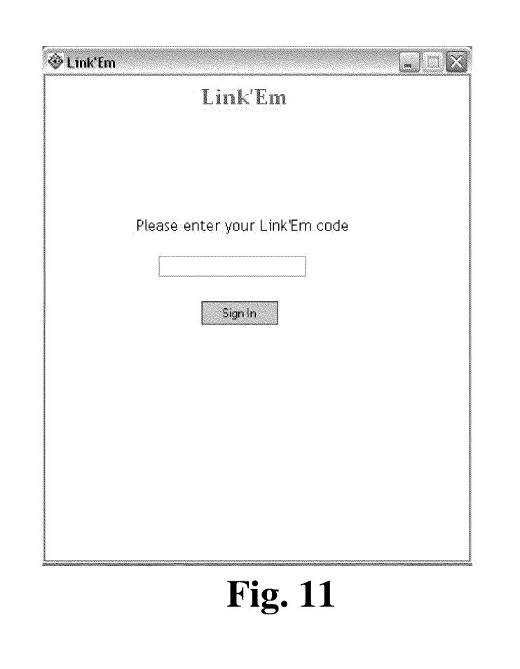

With reference again to FIG. 1, and now FIG. 11, during execution of the program, i.e. setup of the application, the end user may be prompted by the client application, or the server application, for a pass-code 150 or activation code, or user specific information i.e. a textbox, selectable list, or the like, which may be delivered with the client installation application or in alternate embodiment at a different time and manner than that of the client installation application. The pass-code 150 may be used to identify a particular end user or group of end users, thereby allowing the host system 120 to customize communication with that individual end user or group, based on different criteria. It follows that different pass-codes 150 may be distributed to different end users or groups based upon the end user's relationship with the host 120. However, it is noted that the same client installation application may be used for every type of end user. For example, one type of pass-code 150 may identify the end user as a prospect as it relates to a particular company or business, which may be a financial planning, financial advising firm, other professional service firm, or any type of business. The communication portal between client 110 and server systems 120 may therefore display marketing and/or sales information, client reference information, industry web links, contact information or any information suitable for an end user in a prospect group. Another pass-code 150 may identify the end user as an existing client or customer. The information displayed in that communication link may therefore include information and links necessary for carrying on business with an established client or customer. It is noteworthy to mention that certain information and/or web links may be consistently provided to every end user, i.e. for every established connection portal, an example of which may include the host contact information. In yet another embodiment, the pass-code 150 may also be used to identify a particular administrator or advisor, depending on whether the server application is installed on a server 120 or client system 110. In this embodiment the pass-code 150 may identify the privileges the administrator or advisor has, thus eliminating the steps of setting up basic rights for such users. The pass-code 150 may further identify security parameters for the users, i.e. whether a user has the authority to delete accounts, or which advisors may become administrators for their own groups. It is also noted here that while the embodiments described herein relate specifically to commerce, other applications will become apparent to those skilled in a particular art. All such applications are to be construed as falling within the scope of coverage of the embodiments of the subject invention.

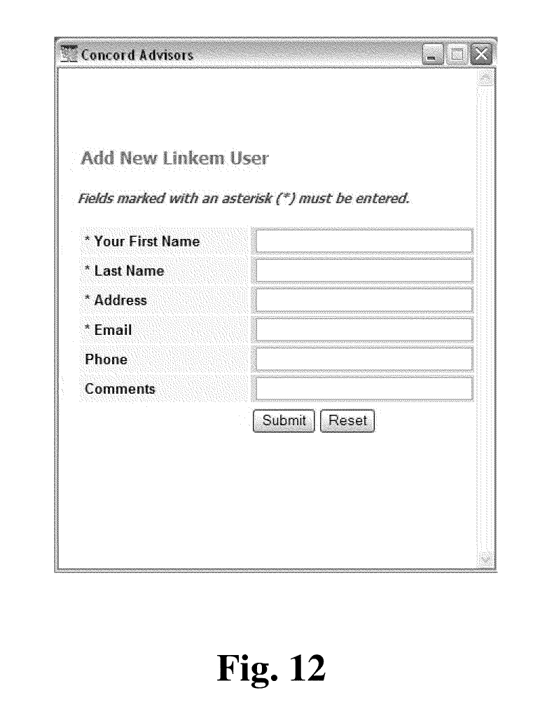

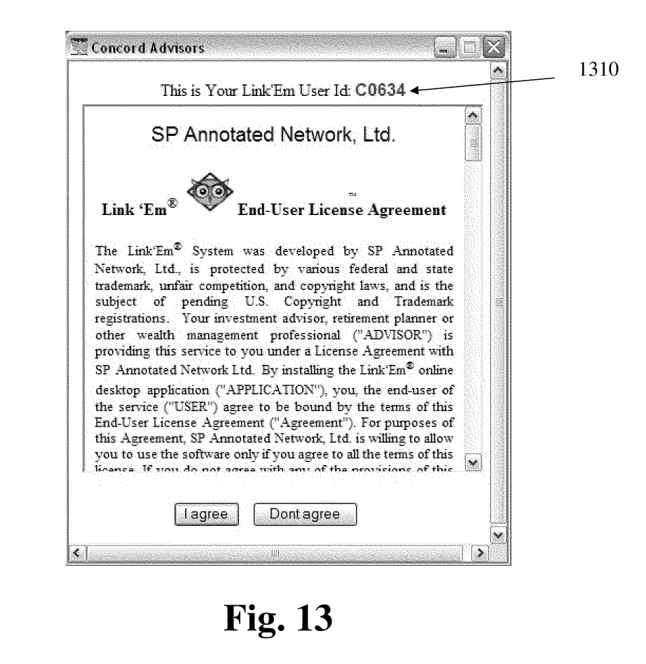

With continued reference to FIG. 1 and now also FIG. 12, separate from the pass-code 150, additional information may be submitted to the server system 120 for identifying the particular end user registering with the host 120. Examples may include but are not limited to contact information like name, address, phone number and password information for accessing the server system 120. However, the installation application may be set up to receive any type of user supplied information deemed suitable for use in a particular business or application. Once the user supplied information is submitted, the server system 120 may process the information and set up the end user based upon their status as initially identified by the host 120. As shown in FIG. 13, a unique user name 1310 may be established by the user of the application, or generated by the server system 120 and sent to the end user. It is noted here that the unique user name 1310 may identify or categorize the end user by their status or current relationship with the host 120. To log on to the server system 120, end user may enter the group ID or user name 1310, and if required a security password. In yet a further embodiment, if the user ID 1310 is set up prior to the creation of a pass-code 150, the server system 120 may create a pass-code 150 specific to the user ID 1310, and communicate this pass-code 150 to the client system 110, wherein the pass-code 150 may be stored on the client 110 or server system 120, to later identify the user ID 1310 specific criteria.

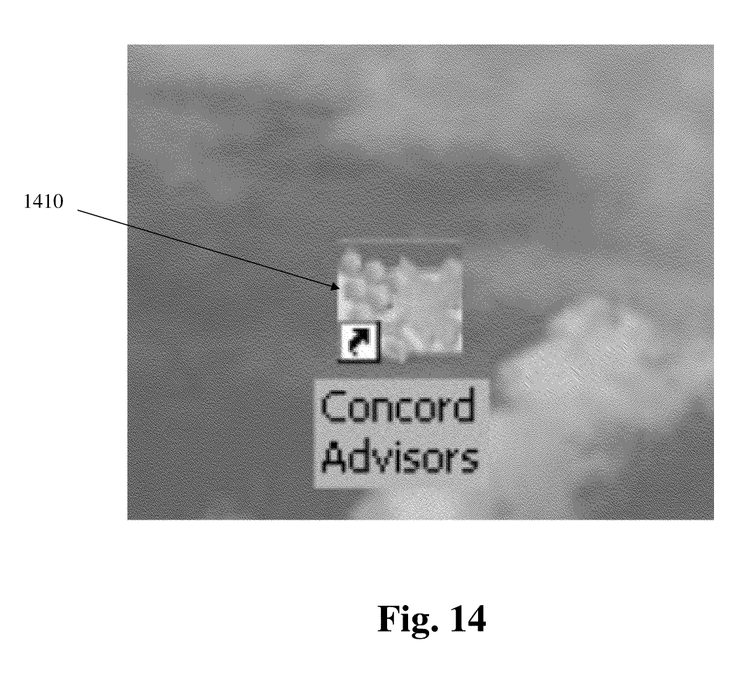

Subsequently, with reference to FIG. 14, the icon placed on the client system 110 display screen “desktop” may then be substituted with another icon, or if a installing an icon was not selected, a new icon 1410. This new icon 1410 is different from the original icon 150 in several ways. Similarly, the new icon 1410 may run a program stored on the client system 110, which as discussed herein, establishes the network communication link with the server system 120. It is noted that the installation application may be deleted from the client system 110 or remain dormant as determined by the end user or the host 120. Additionally, new icon 1410 may be different in appearance. Specifically, the new icon 1410 may represent a host entity, criteria, or a group by graphical means. That is to say that the new icon 1410 may depict the logo or other identifier of the host entity. In this manner, the end user is presented with the graphic representation of the host entity every time the end user looks to the client system 110 display screen desktop. The new icon 1410 may also be selected from a group of icons provided by the host, or the user.

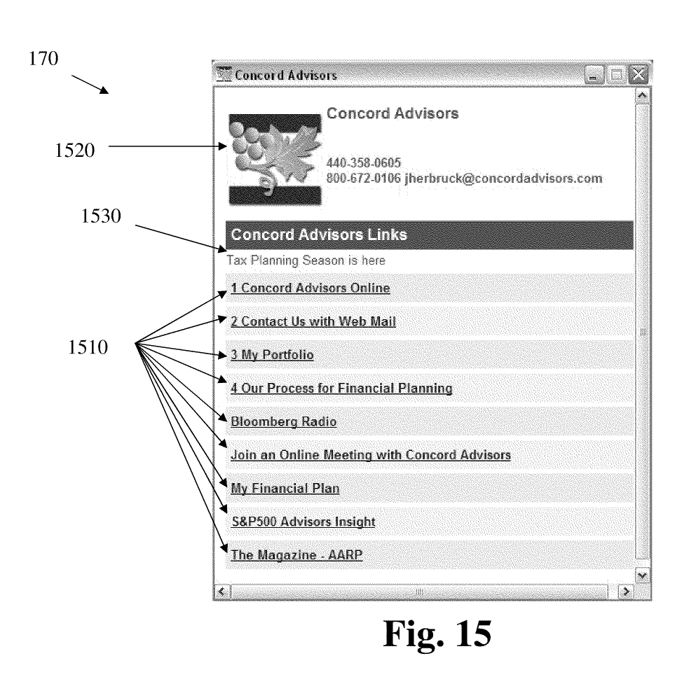

With continued reference to FIG. 1, and also now FIG. 15, in conjunction with establishing the network communication link, which may be a function of clicking on the new icon 1410 as mentioned above, a display screen window may be opened that is populated with user selectable links 1510 as set up for the particular type of registered end user. The selectable links 1510 may be populated from a datafile (not shown), such as a database which will be discussed further below, of information related to the criteria of the user. In one embodiment, the window, or communication portal 170, displays a list of web addresses 1510, i.e. links to other web sites. In the example of a financial advising service, web links may be displayed for accessing investment information or for reporting current market activity. Other links 1510 may be displayed in the window that, upon activation will download brochures or display prospectus information. Additionally, links 1510 to document files may appear in the portal, i.e. a portable document file (PDF), or links 1510 to videos or applications may appear in the portal 170 based on the user or other criteria. Video clips may be selected for display within the portal 170 as a banner ad or using a flash player. Since the portal is controlled by the host 120, any type of information accessible by the Internet may be presented within the communication portal 170. In one embodiment, once the information 1510 is selected within the portal 170, an additional application may open up on the client system 110 to display the information retrieved from the link, i.e. applications including but not limited to, Microsoft® Internet Explorer for a link to a website, or a PDF viewer for a link to a PDF file, or other programs that correspond to various file types. The website appearing in the internet explorer browser may be displayed through the system server secure connection, or in the alternative, it may display the website outside of the system server security parameters. For example, if a user clicks on a link www.hellopatentoffice.com, the address bar in the browser may display the link as the web address, or the web address may be preceded by the host system server information i.e. https://linkem.com/?/securedconnection/gotoweb/www.hellopatentoffice.com.

In an alternate embodiment, once a link 1510 is selected, the information may be viewed within the communication portal 170 itself. In this embodiment, controls are present within the portal 170 to allow the user to navigate through the information selected. The controls may include, but are not limited to, opening a new tab when selecting a link, or a back button to return to the list of links 1510. Alternatively, the controls may appear outside of the portal 170 in a separate window. In this configuration, the controls itself may open in the default display window for the operating system, however, the controls maintain its ability to assist the user with their activity within the portal 170. The options to have the information open using the above described methods may be chosen by the user at the time of installation, or changed using a control panel or the like, a user preferences option after installation or the like, or by any other means known to a person of ordinary skill in the art. Of course, it is to be understood that information displayed or presented for access through the communication portal 170 is duly authorized, either because it is public information or because the host 120 subscribes to a particular service. The secured connection described herein, may be established by security firewalls, i.e. a Cisco® ASA 5500 series firewall, or any other means known to a person having ordinary skill in the art. The secured connection is illustrated to show how a user accesses information to outside sources while maintaining a secured connection within the embodiments of the invention.

Referencing again FIG. 15, additional information may be presented or displayed presented within the communication portal 170. In one embodiment, the host 120 may be able to display images 1520, graphics and/or video that communicate a particular message 1530 to the end user. Additionally, text may be included, examples of which may include a company slogan or timely message pertaining to a certain industry or social event. Even audio may be transmitted via the communication portal 170 as facilitated by the established network communication link. In fact, any means of communicating messages to the end user may be chosen as is appropriate for use with the embodiments of the present invention. Such images or graphics may be displayed using a flash player or any other video player that supports the file format of the video content. Accordingly, if a system does not have a video player that supports the content selected from the portal, a link or notice may be provided to the user with information on obtaining the necessary player. Additionally, the user may elect to use the video player embedded into the portal 170 which may support all image, audio, and video formats, or the like, in addition to all other types of formats. Further, video conferencing may be accomplished using the video software embedded into the portal 170. Of course, it will be appreciated that the host 120 has direct access to alter the content of the additionally presented information at any time. Moreover, the server system 120 may be set up to present information based on the particular relationship status of an end user. For example, new clients, or groups of clients, as may be determined by a client origination date, are presented with a welcome message. Existing clients may be presented with a unique message based on their time as a client. Additionally, help messages may be presented. Advertisement materials may be presented and may be based on the criteria of the user. For example, a financial user may have a banner advertisement that displays current stock market rates and discounts for signing up with a particular stock trader. Coupons may be displayed for a user to select, download, print, or save. Still, any type of message or message content, and any way of determining which message is presented through the communication portal 170 may be selected by the host 120. It is expressly noted here that while the host 120 maintains manual control over the content of the communication portal 170, automatic control may also be facilitated by a server side application as will be discussed further below. In this manner, the end user may review the communication portal 170 for web links 1510 and/or information that will assist them in the specific activity associated with the host 120. It is noted that any information generated within the portal 170 may be refreshed by the user using the operating system specific refresh key, i.e. Microsoft Windows® F5 key. In an alternate embodiment, the information within the portal 170 has an automatic refresh rate, using a system timer. An example of a refresh is now discussed for illustration purposes. When information is refreshed, content is typically updated with current changes, for example, a stock link to a trading website may contain statistics showing a one percent increase in cost of gold as of 12:00:30 pm Eastern Time. Once the screen refreshes, that same link may update and now contain new information about the same statistics reflecting a two percent decrease in the cost of gold as of 12:00:31 pm Easter Time Zone. The refresh feature may provide constant updates of information.

In yet a further embodiment of the present invention, a “pop-up” notifier (not shown) may appear on the users screen, or in audible, advising the user that new information is available. For example, after the portal 170 receives a new link 1510 or new information, a “pop-up” menu appears. This menu may contain a coupon, a coupon code, a link to a coupon, a simplified message about the new information, an image, or any other information commonly communicated via the web, for the user to select. Once the user selects the contents of the “pop-up”, an application, like a browser may be executed. Alternatively, the portal 170 may be used as a means to communicate the information from the “pop-up” to the user, once it is selected. Thereafter, the user is directed to either apply a code, if it is a coupon code, or taken to the website related to the “pop-up” selection.

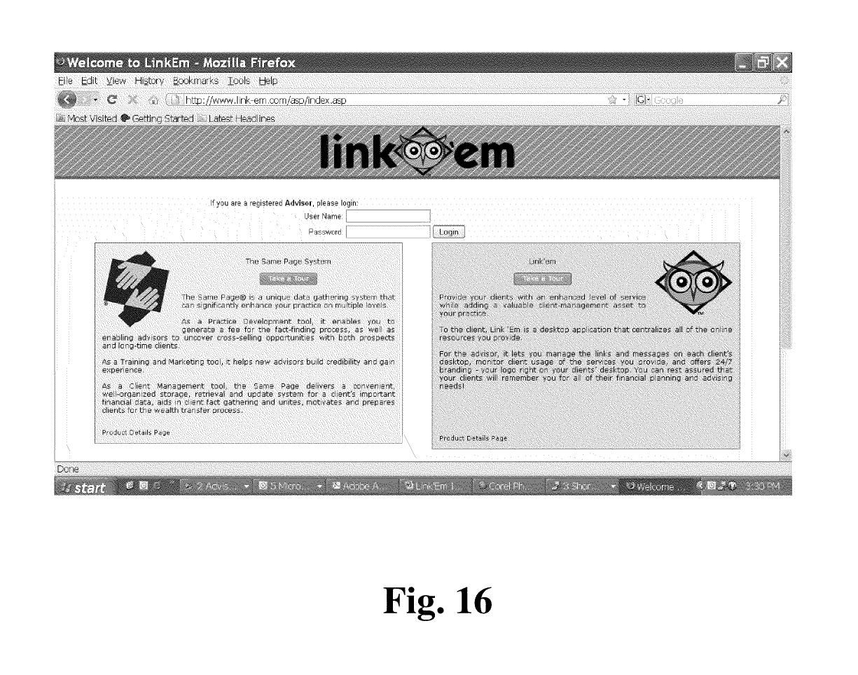

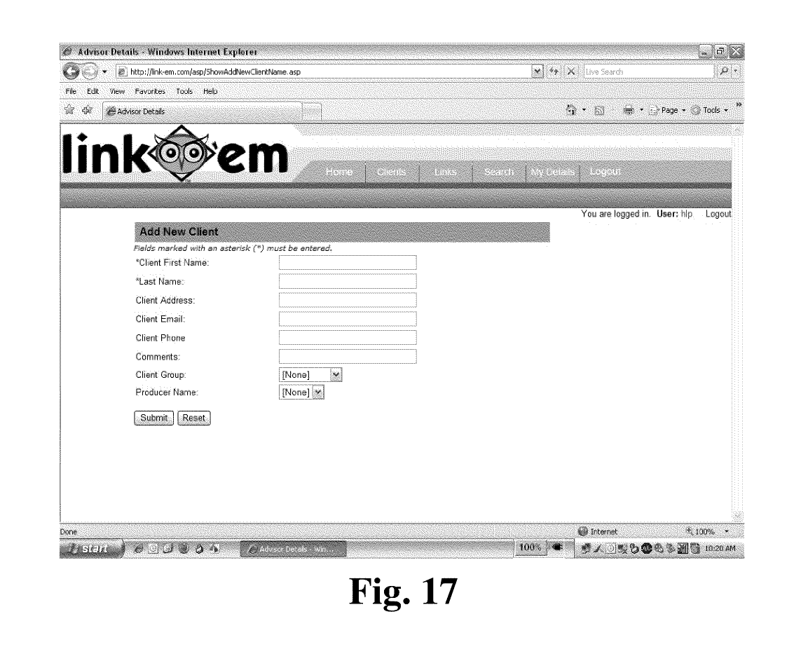

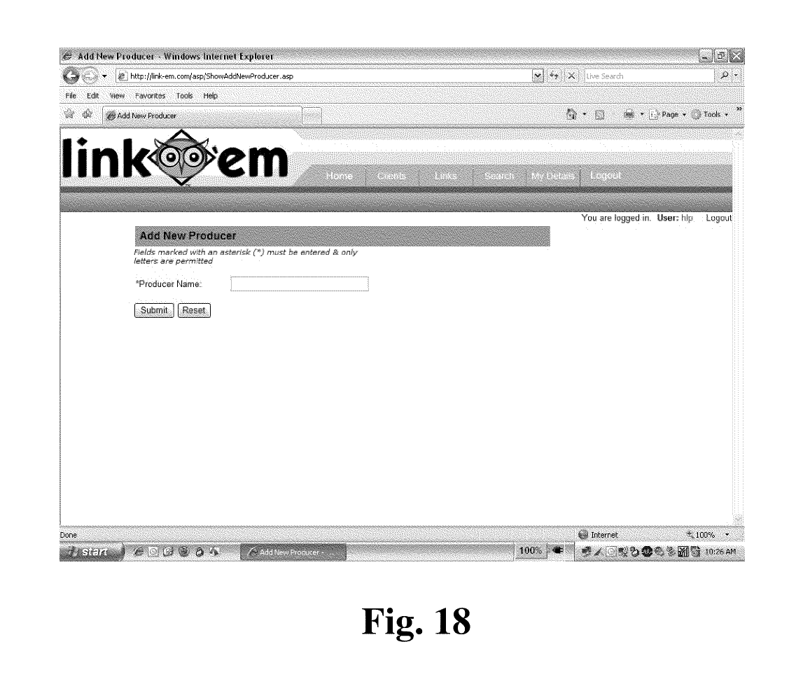

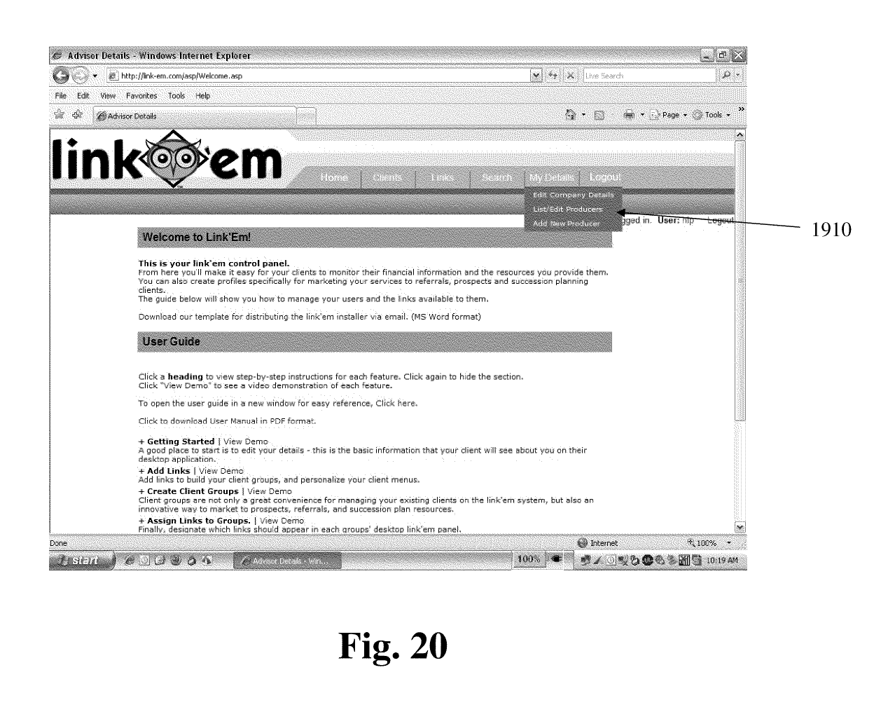

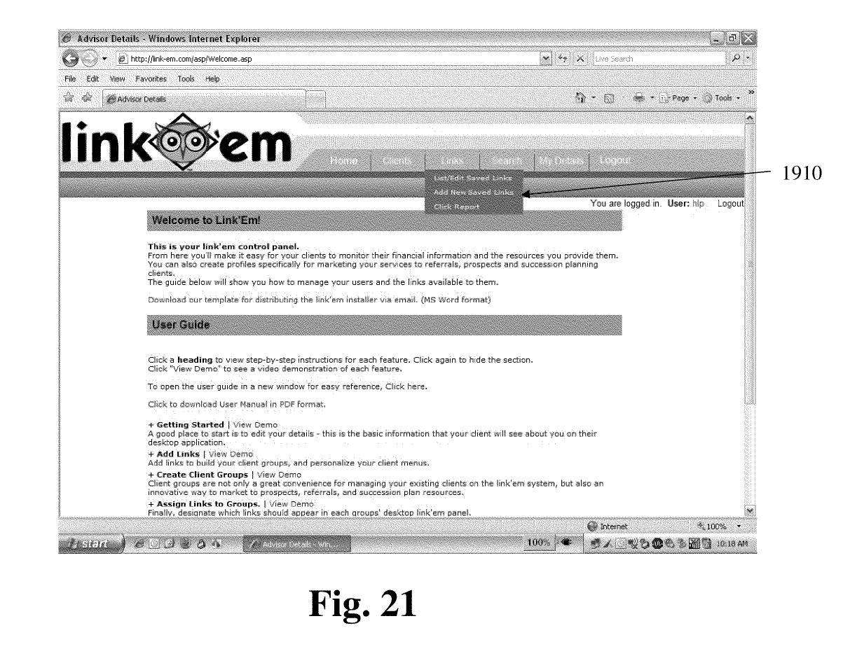

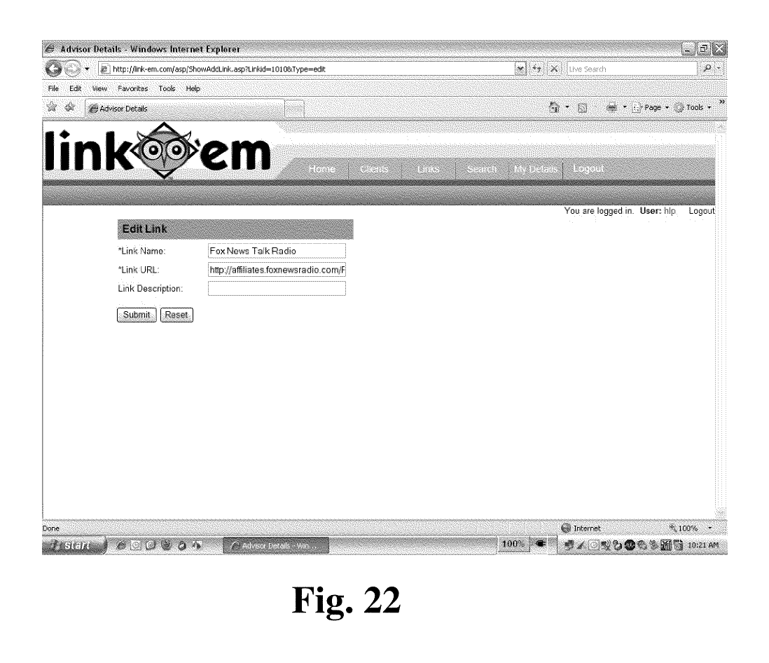

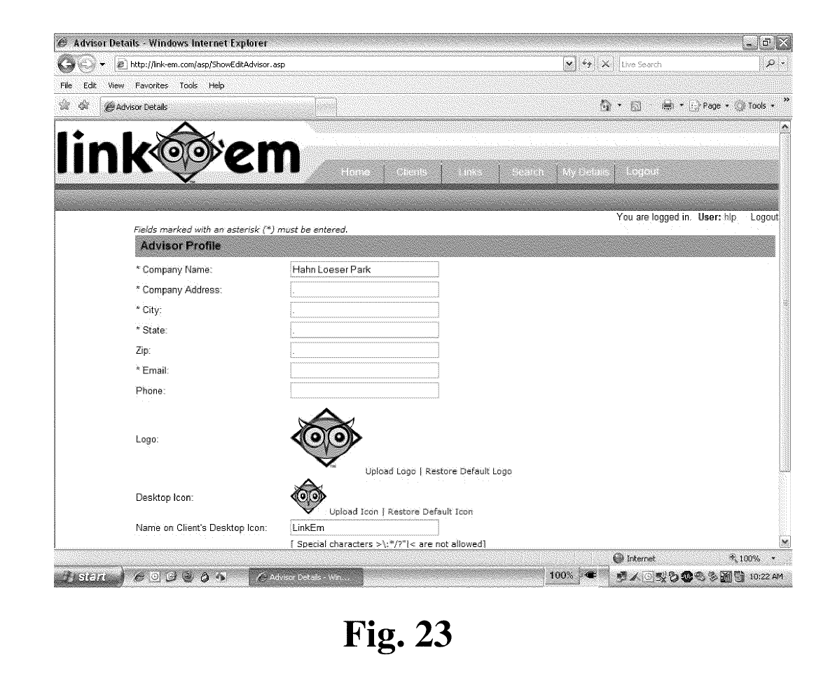

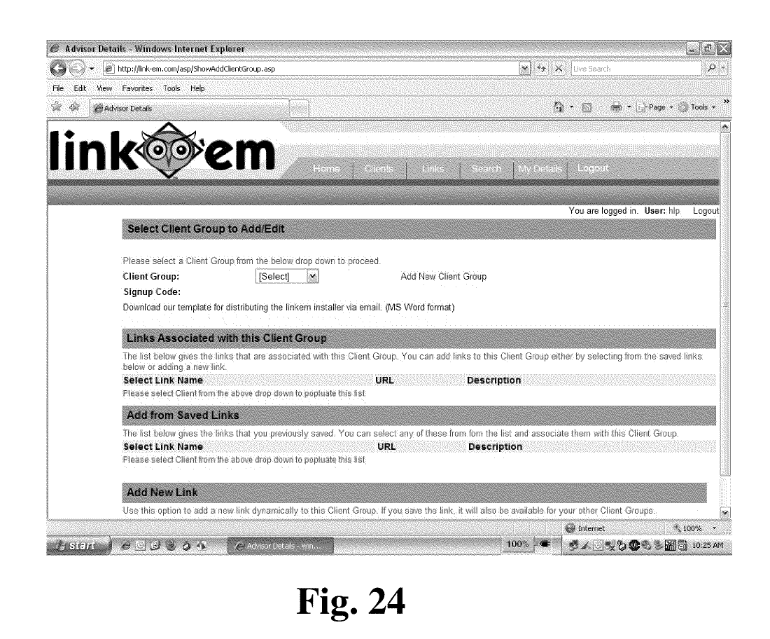

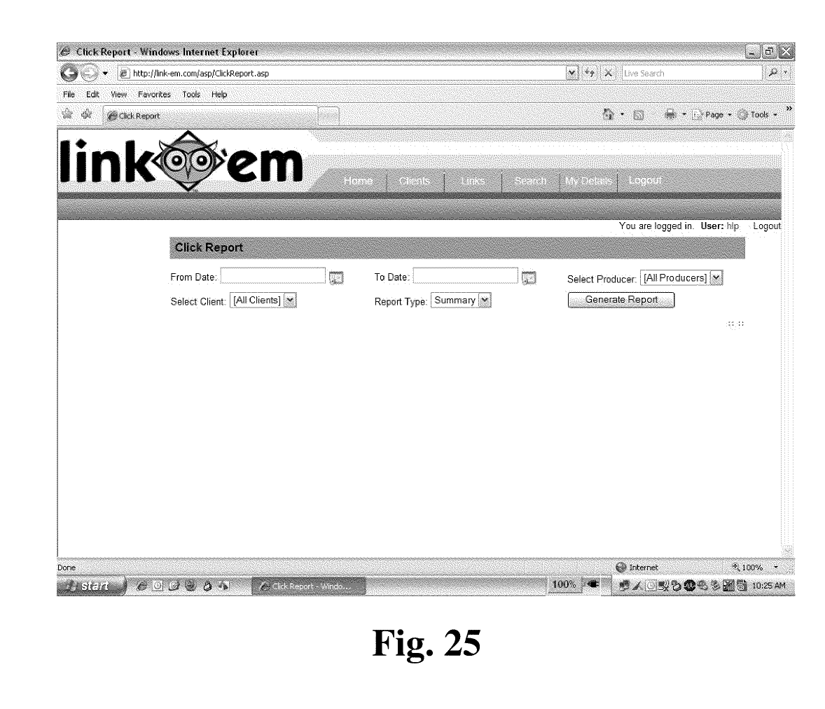

With reference now to FIGS. 16 through 25, as previously indicated, the second component of the linking software comprises an administrator utility or control panel. In one embodiment, the administrator utility provides functions that allow the host 120, and more specifically a host administrator, also termed administrator user, to make changes and to manage what is presented in the communication portal 170. The administrator utility may be secured from unauthorized access by security measures including but not limited password authorization. In this way, the number of administrator users may be securely managed. It is noted that multiple administrator user may be allowed access to the administrator utility as chosen as may be deemed necessary by the host 120.

The administrator utility and its functions are resident in a program, the source code of which is incorporated by reference and included with the specification. In one embodiment, the administrator utility stores and retrieves data as related to the use of the system, which may be captured in a database. The database may be comprised of data tables and indexes as controlled by a database manager, i.e. database manager program. Access to the data may be restricted to one or more super-users or administrators having special access to the data. Advisors may also have administrative privileges or they may be restricted to control of their own users content. In one embodiment, the super-user may have the authority to prevent administrator users from accessing the administrator utility. In this way, administrator users registered with the server system 120, and in particular the administrator utility, may be selectively activated or deactivated by the super-user.

Information stored in the database may include user specific and/or group specific data. The kind of data stored in the database may include but is not limited to: user contact information, personal information, group status, i.e. the group or groups to which the end user is assigned to. Additional information may be stored that relates to the web links associated with a specific group, which is presented to the end user in the communication portal 170 when signed into the server system 120. Other data may be stored that is specific to the end users system activity, i.e. use of the system, including for example connection time or which web links 1510 listed in the communication portal 170 were accessed by a user, or any type of report data, which may be later generated and reported may be captured by the database. Still, the database may contain any type and/or quantity of information necessary for administrating the methods and systems of the embodiments of the subject invention.

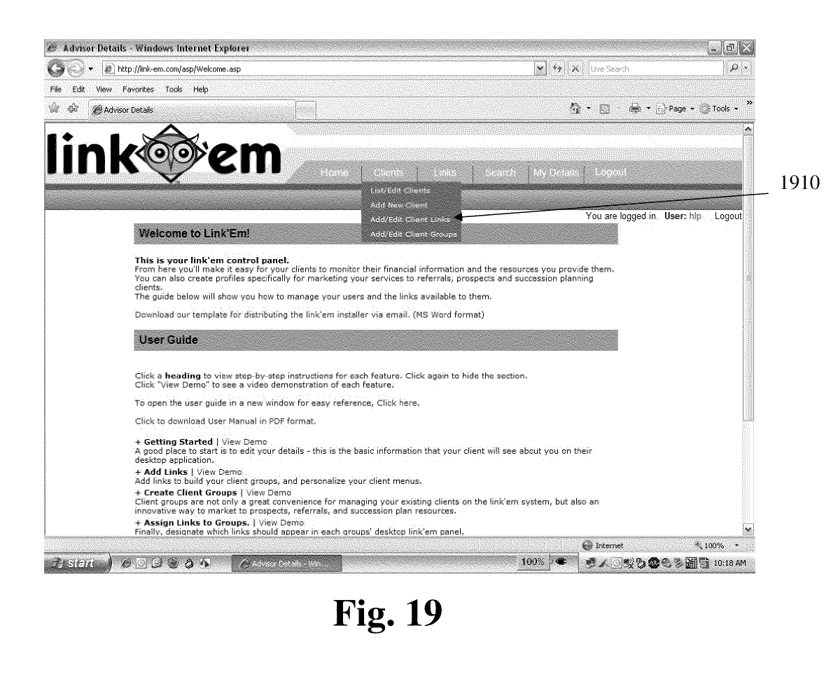

The administrator utility further provides specific functions that allow the administrator to change the information presented in the communication portal 170. As shown in FIGS. 19-21, drop down menus 1910 may be coded into the administrator utility that allow the administrator user to add new clients or the like, new clients groups or the like, or any other category. Additionally, the administrator utility allows the administrator user to change or delete users from one or more groups, or to create global link libraries, which may contain a pool of commonly used links created for specific criteria, for new users.

The groups may be categorized by various criteria as chosen by the host. Examples of criteria for grouping end users may be based on how much business an end user does with the host or another entity, or how much business is anticipated during a specific time period. Other criteria may be based on which industry or business sector the end user works in. Still, any manner of setting up and grouping end users may be selected without departing from the intended scope of coverage of the embodiments of the subject invention.

Still, other functions provide the administrator user with the capability to change the information, e.g. web links 1510, associated with a particular user group. That is to say that a specific list or set of information, comprising brochures, web links and the like, may be associated with a particular group. In this way, information, which may be web links 1510 for example, may be linked to a specific group for display in the communication portal 170 when the end user logged on the system 120. It will be appreciated that changing information linked to a specific group will correspondingly change the information displayed in the communication portal 170.

In another embodiment, the host system 120 may automatically update link information in near real-time. In this embodiment, as information, brochures and the like change on specific websites, the updated links 1510 are displayed in the portal 170. For example, the server application, may monitor the status of links on a particular website, i.e. stock movement on a financial website, then as the status changes for that link, the server application may send the update to the database. The updated information is then displayed in then displayed in the portal 170. It is also possible, for the server application to send the updated information directly to the portal 170, however, for auditing purposes the preferred method is to have information communicated to the database.

It is noted here that the source code for the client installation application and/or client side application, along with the source code for the administrator utility and/or server side application software is included herewith and is expressly incorporated by reference. The source code for all associated programs is being submitted on compact disc and is referred to as the computer program listing appendix.

The invention has been described herein with reference to the disclosed embodiments. Obviously, modifications and alterations will occur to others upon a reading and understanding of this specification. It is intended to include all such modifications and alterations insofar as they come within the scope of the appended claims or the equivalence thereof.

1. A method of customizing information displayed on a computer-based system via a communication portal, comprising the steps of:
providing a first computer program product executable on a computer-based system having electronic memory and a terminal for displaying information, wherein the computer program product is adapted to establish a data link between first and second computer-based systems over a network;
providing a second computer program product executable by a second computer-based system having electronic memory, wherein the second computer program product is adapted to compare end-user information received from the first computer program product;
prompting an end user to install the first computer program product;
prompting the end user to enter user-specific information, wherein the user-specific information is received by the second computer program product;
communicating user specific information entered by an end user through the first computer program;
opening a display portal visible on the terminal for displaying information; and,
displaying information within the display portal responsive to the user specific information entered by the end user.

2. A method of customizing information displayed on a computer-based system via a communication portal, comprising the steps of:
providing a first computer program product executable on a computer-based system having electronic memory and a terminal for displaying information, wherein the computer program product is adapted to establish a data link between first and second computer-based systems over a network;
providing a second computer program product executable by a second computer-based system having electronic memory, wherein the second computer program product is adapted to compare end-user information received from the first computer program product;
prompting the end user to activate the first computer program product;
receiving pass code information entered by an end user through the first computer program product;
validating the pass-code information with reference to predefined data for authorizing access to pass code specific criteria;
opening a display portal visible on the terminal for displaying information; and,
displaying information within the display portal responsive to the pass code specific criteria.

3. The method as defined in claim 2, wherein the information displayed in the display portal is customized for a predefined entity, and
wherein said pass-code information comprises information that identifies the end user as one of a plurality of predefined entities.

4. The method as defined in claim 2, wherein the information displayed comprises one or more web address links.

5. The method as defined in claim 4 wherein the web address links are supplied from a datafile accessible by the second computer program product.

6. The method as defined in claim 4, wherein the information displayed within the display portal is customizable by the end user.

7. The method as defined in claim 2, wherein the information displayed comprises information in a document file.

8. The method as defined in claim 2, further comprising the step of:
displaying a user selectable icon on the terminal for opening the display portal.

9. The method as defined in claim 2, wherein the first computer-based system is a client computer and the first computer program product is a client-side computer program product, and
wherein the second computer-based system is a server computer and the second computer program product is a server-side computer program product.

10. The method as defined in claim 2, further comprising the step of:
making the first computer program product accessible for installation onto the first computer-based system, whereafter the first computer program product is installed onto and executed by the first computer-based system.

11. The method as defined in claim 10, wherein the first computer program product is accessible for installation onto the first computer-based system via a wide-area-network.

12. The method as defined in claim 10, wherein the first computer program product is accessible for installation onto the first computer-based system via the internet.
